(19) United States
(12) Patent Application Publication
(10) Pub. No.: US 2020/0241128 A1
(43) Pub. Date: Jul. 30, 2020

(54) APPARATUS CONTROL SYSTEM AND CONTROL METHOD

(71) Applicant: RENESAS ELECTRONICS CORPORATION, Tokyo (JP)

(72) Inventors: Shinichi UCHIDA, Tokyo (JP); Nobuyuki MORIKOSHI, Tokyo (JP); Tomoyuki TANAKA, Tokyo (JP); Yoshiyuki OTA, Tokyo (JP); Ryo YOKOTA, Tokyo (JP); Yuji MOTODA, Tokyo (JP)

(21) Appl. No.: 16/737,556

(22) Filed: Jan. 8, 2020

(30) Foreign Application Priority Data
Jan. 25, 2019 (JP) 2019-011256

(51) Int. Cl. G01S 13/89; G06K 9/00; G01S 13/06

(52) U.S. Cl. CPC G01S 13/89; G01S 13/06; G06K 9/00308

(57) ABSTRACT

A device control system comprises an object detection circuit configured to detect an object around a device to be controlled, an attribute identification circuit configured to identify an attribute of the device, and a control circuit configured to control the device based on a result of the detection by the object detection circuit and the attribute of the object identified by the attribute identification circuit. According to the above embodiment, it is possible to control the device without the user being aware of it.

### CROSS-REFERENCE TO RELATED APPLICATIONS

The disclosure of Japanese Patent Application No. 2019-11256 filed on Jan. 25, 2019 including the specification, drawings and abstract is incorporated herein by reference in its entirety.

### BACKGROUND

The present invention relates to a device control system and a control method. Some devices control the state of use of the device in response to some action on the device, e.g., face authentication. For example, Japanese unexamined patent publication No. 2012-68948 discloses a technique of the face authentication described above.

### SUMMARY

Incidentally, in the case of the face authentication as described above, it is necessary for the user to perform an operation to explicitly perform the face authentication, but it is desirable to be able to control the device without the user's operation, that is, without the user's awareness.

Other objects and novel features will become apparent from the description of the specification and the accompanying drawings.

Summaries of typical embodiments of the embodiments disclosed in the present application will be briefly described as follows.

A device control system comprises an object detection circuit configured to detect an object around a device to be controlled, an attribute identification circuit configured to identify an attribute of the device, and a control circuit configured to control the device based on a result of the detection by the object detection circuit and the attribute of the object identified by the attribute identification circuit.

According to the above embodiment, it is possible to control the device without the user being aware of it.

### BRIEF DESCRIPTION OF THE DRAWINGS

FIG. 1 is a diagram showing an outline of a configuration example of the device control system of the first embodiment.

FIG. 2 is a flowchart for explaining a processing procedure for controlling a controlled device in the first embodiment.

FIG. 3 is a diagram showing an outline of a configuration example of the device control system of the second embodiment.

FIG. 4 is a flowchart for explaining a processing procedure for controlling a controlled device in the second embodiment.

FIG. 5 is a flowchart for explaining a processing procedure for controlling a controlled device in the third embodiment.

FIG. 6 is a flowchart for explaining a processing procedure for controlling a controlled device in the fourth embodiment.

### DETAILED DESCRIPTION

Hereinafter, the present embodiment will be described in detail with reference to the drawings. In all the drawings for explaining the embodiments, the same parts are denoted by the same reference numerals in principle, and repetitive descriptions thereof are omitted. On the other hand, in the description of the other drawings, the same reference numerals are sometimes given to parts that have been described with reference numerals in certain drawings, although they are not illustrated again.

### Embodiment 1

(System Configuration)

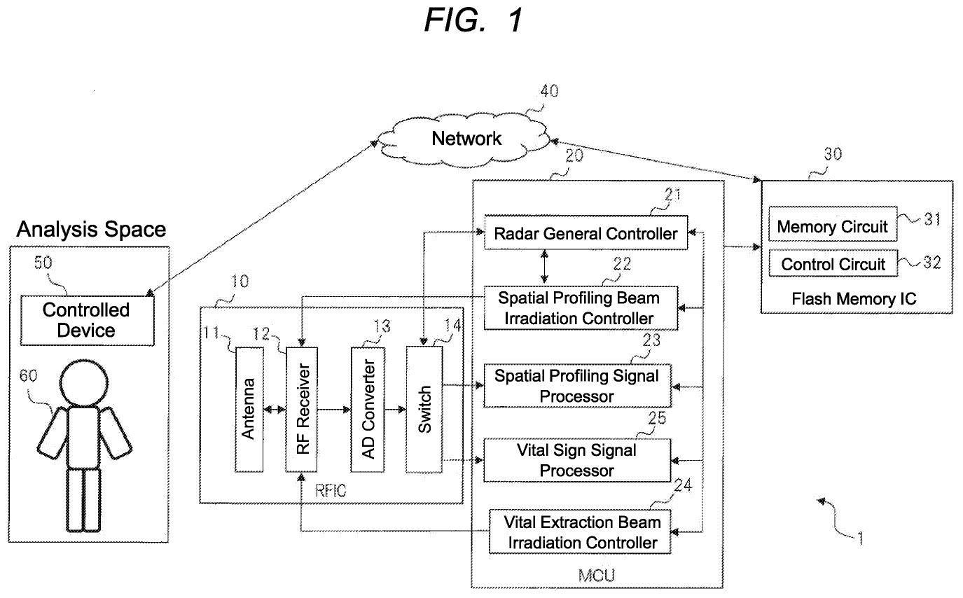

In the first embodiment, in the device control system, the device to be controlled is controlled on the basis of an attribute of an object existing around the device to be controlled, and the like. FIG. 1 is a diagram showing an outline of a configuration example of a device control system according to the present embodiment. The device control system 1 includes a RFIC 10, an MCU 20, and a flash memory IC 30. The device control system 1 controls the controlled device 50 based on the attributes of the object 60 existing around the controlled device 50 (the device to be controlled) disposed in the analysis space (e.g., an area in a certain range such as a room). Here, the attribute indicates the type of the object 60 such as a child or an adult. Further detailed types (mother and father) may be used.

The device control system 1 is a so-called millimeter wave radar system, includes a spatial profiling analysis mechanism and a vital sign analysis mechanism, and can analyze space and vital. In the first embodiment, the frequency band is assumed to be 76-81 GHz of the IMS band, but any other frequency may be used as long as it is a radar having a spatial profile or a frequency capable of vital sensing.

The RFIC 10 is an integrated circuit (RFIC(Radio Frequency Integrated Circuit) that processes RF signals, and includes antennas 11, RF transceivers 12, A/D converters 13, and switches 14. The RFIC 10 may be installed around the controlled device 50 or may be a one-chip integrated with the MCU 20.

The RFIC 10 antenna 11 is a phased array antenna for transmitting and receiving millimeter-wave radar to and from the analysis space. The antenna 11 may be a single antenna or a plurality of antenna groups. In addition, the antenna 11 may be configured separately as a transmitting antenna and a receiving antenna, or may be provided outside the RFIC 10.

In the spatial profiling, phase control of the transmission beam is performed to control the transmission beam irradiation direction. Thus, the position and shape of the object 60 are identified.

The RF transmitter/receiver 12 is configured by a circuit for processing an RF signal such as a power amplifier for transmission, a phase shifter, a low noise amplifier, and the like, and is a portion for performing millimeter wave radar signal processing.

The AD converter 13 is a so-called AD converter and converts the baseband analog signal output from the RF transmitter/receiver 12 into a digital signal.

The switch 14 is a portion for switching the processing destination of the data of the spatial profiling and the data of the vital signs. The switch 14 switches the processing destination of the data of the spatial profiling and the data of the vital signs in accordance with the control signal transmitted from the radar general controller 21.

The RFIC 10 may be irradiated with beams based on the size of the analysis space. As a result, it is possible to easily detect whether or not the object 60 has entered the analysis space.

The MCU 20 is a memory controller (MCU (Memory Controller)), and includes a radar general controller 21, a spatial profiling beam irradiation controller 22, a spatial profiling signal processor 23 (object detecting unit), a vital extraction beam irradiation controller 24, and a vital sign signal processor 25. The flash memory IC 30 includes a storage unit 31 (attribute storage unit) and a controller 32 (attribute specification unit, controller), and may be a flash memory circuit incorporated in an MCU 20. The controllers 21, 22, and 24 and the processors 23 and 25 may be configured by software.

The radar controller 21 controls the entire MCU 20. That is, the radar general controller 21 controls the spatial profiling beam irradiation controller 22, the spatial profiling signal processor 23, the vital extraction beam irradiation controller 24, and the vital sign signal processor 25. As described above, the entire radar controller 21 controls the entire MCU 20 to exchange the status of device control determination/result confirm using the flash memory IC 30, and to control the treatments of space, objects, and vitals.

For example, the radar general controller 21 sends out a control signal to the spatial profiling beam irradiation controller 22 to irradiate the beam at a predetermined timing. When the radar general controller 21 receives the information indicating that the object 60 is specified from the spatial profiling signal processor 23, the radar general controller 21 switches the switch 14 to the acquisition of the vital sign. In addition, the radar general controller 21 sends a control signal to the vital extraction beam irradiation controller 24 to irradiate the vital extraction beam.

When the whole radar controller 21 acquires vital information from the vital sign signal processor 25, the whole radar controller 21 stores information indicating that the object 60 has been specified and the vital information in the flash memory IC 30.

The spatial profiling beam irradiation controller 22 controls the RF transmitter/receiver 12 to irradiate a beam for analyzing spatial profiling. The spatial profiling beam irradiation controller 22 receives the control signals from the radar general controller 21, and in response thereto, the spatial profiling beam irradiation controller 22 controls the RF transmitter/receiver 12 so that the RF transmitter/receiver 12 can transmit and receive a frequency-modulated continuous wave (FMCW) using the phased array antenna.

The spatial profiling signal processor 23 detects an object 60 around the controlled device 50. Specifically, the spatial profiling signal processor 23 acquires the reflection result of the radar irradiated by the RF transmitter/receiver 12 from the RFIC 10 under the control of the spatial profiling beam irradiation controller 22, and specifies the presence or absence of the object 60, the shape of the object 60, and the like based on the reflection result by a known technique.

Based on the reflection result, the spatial profiling signal processor 23 determines whether or not a portion having a large reflection intensity, i.e., the intensity of the radar reflection signal, has changed, and determines whether or not there is a moving object 60.

When the spatial profiling signal processor 23 identifies the presence of the object 60 as described above, the spatial profiling signal processor 23 continuously identifies the position, the moving speed, and the like of the object 60. The spatial profiling signal processor 23 specifies the shape of the object 60. The spatial profiling signal processor 23 may further grasp the space.

The spatial profiling signal processor 23 may specify a plurality of objects 60. When the object 60 is specified, the spatial profiling signal processor 23 transmits information indicating that the object 60 is specified to the radar general controller 21. The spatial profiling signal processor 23 stores information indicating that the object 60 is specified in the flash memory IC 30. Here, the information indicating that the object 60 is specified is information including the number of specified objects 60, the position of the object 60, the shape of the object 60, and the like.

The vital extraction beam irradiation controller 24 controls the RF transmitter/receiver 12 to irradiate a beam for analyzing the object 60. That is, the vital extraction beam irradiation controller 24 controls the RF transmitter/receiver in response to a control signal from the radar general controller 21, and performs beam irradiation control for sensing vital so that the object 60 is irradiated with a radar beam whose irradiation range is narrower than that in the case of spatial profiling from the phased array antenna.

The vital sign signal processor 25 receives the vital sign signal acquired from the RFIC 10, and analyzes the signal to specify the vital sign of the object 60.

Here, the vital sign signal acquired from the RFIC 10 is a reflected signal of the radar irradiated on the object 60.

The vital sign signal processor 25 analyzes the acquired vital sign signal and extracts vital information such as a heart rate, a pulse rate, and a blood pressure of the object 60.

More specifically, the vital sign signal processor 25 analyzes the acquired signal by FFT (Fast Fourier Transform), and extracts at least one piece of vital information such as a heart rate, a pulse rate, and a blood pressure as the status information of the object 60. The vital sign signal processor 25 may extract vital information by a known technique. The vital sign signal processor 25 may extract the vital information of the plurality of objects 60. In this manner, the vital sign signal processor 25 extracts the state information of the object 60. The vital sign signal processor 25 sends the extracted vital information to the flash memory IC 30.

The flash memory IC 30 includes a storage unit 31 and a controller 32. The storage unit 31 stores, as attribute reference information, information such as a heart rate, which is the number of beats of the heart of a person who is supposed to stay in the analysis space, a pulse rate, which is the number of beats of the artery, a blood pressure value, and a respiration rate, which are information indicating the reference of the attribute of the object. For example, heart rate, pulse rate, blood pressure value, respiration rate and shape information (height, etc.) of each of the child, the father, and the mother are stored in the storage unit 31 in advance as attribute reference information of each person.

The storage unit 31 may store information indicating the state of the controlled device 50. The storage unit 31 may store information acquired from the MCU 20.

The controller 32 is a portion that controls the controlled device 50, and is configured by, for example, an MCU. The controller 32 is a portion for specifying the attribute of the object 60. The controller 32 acquires information indicating that the object 60 has been specified (shape information (height, etc.) of the object 60, including the position). In addition, the controller 32 acquires the vital data of the object 60 from the MCU 20. The controller 32 compares at least one of the acquired shape and vital information with the attribute reference information stored in the storage unit 31 to identify a person having an attribute.

Specifically, the controller 32 compares the vital information acquired from the MCU 20 with the attribute reference information, and specifies the attribute of the attribute reference information having the value closest to the vital information, thereby specifying the attribute. For example, when the vital information acquired from the MCU 20 is close to the heart rate, the pulse rate, and the blood pressure of the child, the controller 32 identifies the attributes of the object 60 as the child. The controller 32 may also use the shape information for this particular. In this manner, the controller 32 specifies the attribute of the object 60. The controller 32 may compare all of the heart rate, the pulse rate, the blood pressure, and the shape information, or may compare a plurality of heart rate, the pulse rate, the blood pressure, and the shape information. In addition, the controller 32 may compare one of the heart rate, the pulse rate, the blood pressure, and the shape information. The controller 32 may specify the attribute of each object 60 using the vital information of the plurality of objects 60.

Further, the controller 32 controls the controlled device 50 in accordance with the attribute specified on the basis of the result of detecting the object 60. For example, when the controller 32 identifies that the attribute is a child, the controller 32 instructs the controlled device 50 such as an IH stove to control the child lock via the network 40. In addition, the controller 32 registers the fact that the child lock has been performed and the time at which the child lock control has been instructed in the storage unit 31. The network 40 is a wired or wireless network. As a condition for the controller 32 to child-lock the controlled device 50, in addition to the attribute that the child is a child, a condition that the distance between the child and the controlled device 50 using the position of the child as the object 60 is within a preset distance may be included.

In this manner, the controller 32 does not control the controlled device 50 merely based on the detection of the object 60, but specifies the attribute and position of the object 60, and controls the controlled device 50 based on the attribute and position, so that the controlled device 50 can be controlled more appropriately.

When there are a plurality of controlled devices 50, the controller 32 may control the controlled device 50 on the basis of the detection result of the object 60 and the attribute of the object 60 for each controlled device 50.

When it is determined that the child is not around the controlled device 50 continuously from the time when the child lock control instruction is issued in the child locked state, an instruction to release the child lock may be issued.

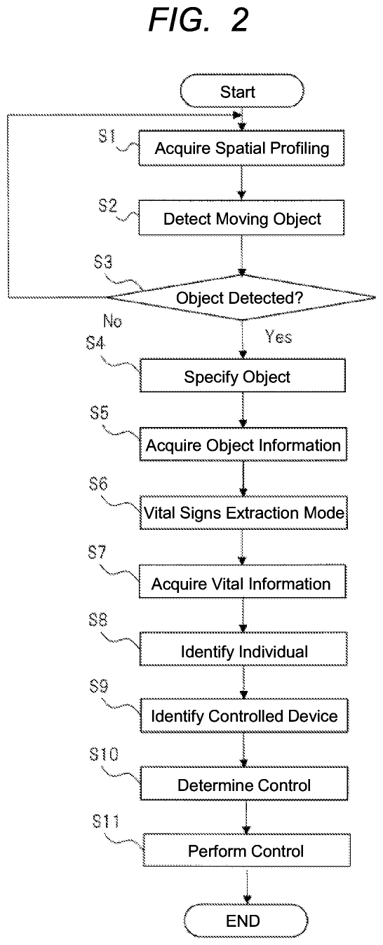

Next, a processing procedure in which the device control system 1 controls the controlled device 50 will be described with reference to the flowchart shown in FIG. 2. FIG. 2 is a flowchart for explaining a processing procedure in which the device control system 1 controls the controlled device 50.

First, at a predetermined timing, the radar general controller 21 requests the spatial profiling beam irradiation controller 22 to irradiate a wide radar beam. In response to this, the spatial profiling beam irradiation controller 22 issues a spatial profiling beam irradiation request to the RF transceiver unit 12. The RF transceiver 12 irradiates a spatial profiling beam through the antenna 11. When the RF transmitter/receiver 12 receives the irradiation result (reflection signal) via the antenna 11 and the AD conversion unit 13, the spatial profiling signal processor 23 acquires the irradiation result (reflection signal). In this manner, the spatial profiling signal processor 23 acquires spatial profiling (a result of irradiation) (step S1).

In step S2, the spatial profiling signal processor 23 analyzes the irradiation result and detects the moving object 60. In step S3, when the object 60 is not detected (step S3:No), the process proceeds to step S1. In step S3, when the spatial profiling signal processor 23 detects the object 60 (step S3:Yes), the spatial profiling signal processor 23 analyzes the motion and the like of the object 60, calculates the position and the moving speed of the object 60, and specifies the shape (step S4). The spatial profiling signal processor 23 transmits information indicating that the object 60 has been detected, information on the position, moving velocity, and geometry of the object 60 as information on the detection of the object 60 to the flash memory IC 30, and the flash memory IC 30 acquires the information in step S5.

In addition, the radar general controller 21 causes the switch 14 to switch to the vital sign extraction mode with the detection of the object 60 by the spatial profiling signal processor 23 as a trigger. Further, the radar general controller 21 requests the vital extraction beam irradiation controller 24 to irradiate the vital extraction beam whose irradiation range is narrower than that at the time of spatial profiling. In response to this, the vital extraction beam irradiation controller 24 requests the RFIC 10 RF transmitter/receiver 12 to irradiate the vital extraction beam. In step S6, the radar general controller 21 converts the mode into the vital signs extraction mode.

The vital sign signal processor 25 receives the reflection signal of the vital extraction beam irradiated by the RF transmitter/receiver 12 in response to the irradiation request of the vital extraction beam via the RF transmitter/receiver 12 or the like. Then, the vital sign signal processor 25 performs signal processing for vital signs to acquire vital signs. For example, the vital sign signal processor 25 receives the reflection signal, performs FFT processing, and analyzes the vibration generated by the object 60, thereby extracting vital information such as a heart rate, a pulse rate, and a blood pressure. In step S7, the vital sign signal processor 25 acquires vital information. The vital signs processor 25 sends the extracted vital signs to the flash memory IC 30. In addition, the vital sign signal processor 25 notifies the radar general controller 21 that the vital information has been acquired. In operation S8, the controller 32 of the flash memory IC 30 compares the vital information acquired from the MCU 20 with the attribute reference information stored in the storage unit 31, and identifies the attribute of the attribute reference information having the value closest to the vital information, thereby identifying the attribute of the object 60. That is, as described above, the controller 32 of the flash-memory IC 30 specifies the attributes of the object 60, thereby specifying individuals.

In operation S9, the controller 32 of the flash-memory IC 30 identifies the controlled device 50 close to the position of the object 60 after identifying the individual. If only one controlled device 50 is used, step S9 may be omitted.

In step S10, the controller 32 determines whether or not to control the controlled device 50 based on the identified individual and the controlled device 50. For example, if the object 60 is a child and the controlled device 50 is an IH heater, the controller 32 determines to perform child locking. When the object 60 is not a child, the controller 32 determines that the child lock is to be released if the child lock is not performed or the child lock is performed on the controlled device 50.

In step S11, the controller 32 performs a control process based on the determination. The controller 32 transmits a control signal to the controlled device 50 via the network 40 based on the determination in step S10, for example.

In the above-described embodiment, the case where the attribute reference information of the object 60 (person, human) which is supposed to use the analysis space is input to the storage unit 31 and the attribute reference information is stored is described, but the present invention is not limited thereto. The controller 32 may compare the acquired vital information with reference information defined in advance (general reference information), and specify the attribute based on the comparison result.

Note that the object 60 may be detected so as to be able to specify whether or not the object 60 has entered the analysis space. For example, this can be realized by defining the area in which the RFIC 10 irradiates the beams on the basis of the width of the analysis space.

Although not described in the above embodiment, the controlled device 50 may be a device such as a cleaning robot that sequentially moves. In this instance, the MCU 20 sequentially acquires positional information from the controlled device 50 via the network 40, and determines whether or not the control processing of the controlled device 50 is necessary by using the positional information and the positional information of the object 60 specified by the spatial profiling signal processor 23.

### <Effects>

As described above, in the device control system 1 that controls the device, the spatial profiling signal processor 23 detects the object 60 around the controlled device 50 that is the control target. In addition, the controller 32 specifies the attribute of the object 60. The controller 32 controls the controlled device 50 based on the detection result of the object 60 and the attribute of the object specified by the controller 32.

In this manner, since the device control system 1 controls the controlled device 50 based on the attribute by detecting the object 60 and further specifying the attribute of the object 60, the controlled device 50 can be controlled without the user being aware of it.

In addition, the storage unit 31 stores information indicating a standard of the attribute of the object 60 for which the use of the analysis space is supposed. The controller 32 identifies the attribute of the detected object 60 by comparing the vital information with the information indicating the reference of the attribute of the object 60. In this case, since the information indicating the standard of the attribute of the object 60 (person, human) assuming the use of the analysis space is stored in advance, the controller 32 can appropriately specify the attribute of the object 60.

Further, the storage unit 31 stores information on the criteria of the blood pressure, the heart rate, and the respiration rate as the criteria of the attributes of each object (person, human), and the controller 32 acquires any plural information of the blood pressure, the heart rate, and the respiration rate as the state information of the object 60, and specifies the attributes of the object based on the acquired information and the information stored in the storage unit 31. In this case, since the controller 32 specifies the attribute of the object 60 using more detailed information, the controlled device 50 can be controlled more appropriately.

### Embodiment 2

In the second embodiment, a device to be controlled is controlled when a plurality of objects 60 (an object (person, human) 60a and an object (person, human) 60b) are detected in a situation where a plurality of controlled devices 50 (controlled devices 50a and 50b) are present.

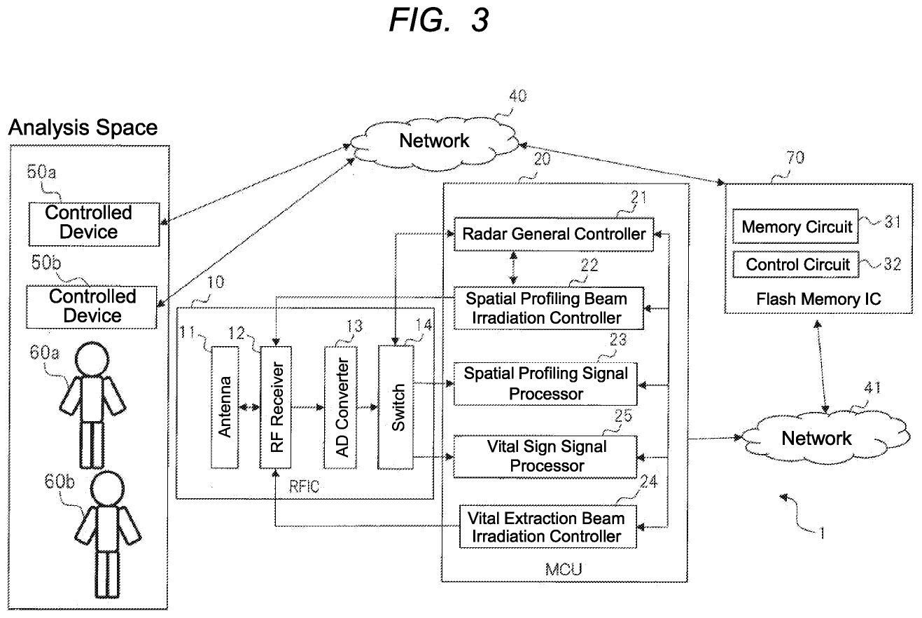

An example of the configuration of the device control system of the second embodiment will be described with reference to FIG. 3. FIG. 3 is a diagram showing an outline of the device control system according to the second embodiment. It should be noted that descriptions of portions common to the functions shown in FIG. 1 are omitted.

The device control system according to the second embodiment includes a RFIC 10, an MCU 20, and a server 70. The MCU 20 and the servers 70 can transmit and receive data to and from each other via the networks 41. The controlled device 50 and the server 70 can transmit and receive information to and from each other via the network 40.

The RFIC 10 is the same as that of the RFIC 10 described in the first embodiment. The MCU 20 is the same as the MCU 20 described in the first embodiment except that it is transmitted and received via the servers 70 and the networks 41. The server 70 is a server device constituting a cloud or a device for realizing edge computing, and includes the storage unit 31 and the controller 32 described in the first embodiment.

The MCU 20 acquires a result of irradiating the RFIC 10 with the spatial profiling beam, detects a plurality of objects 60 using the result, acquires information indicating that the plurality of detected objects 60 are specified, and transmits the information to the servers 70 via the network 41. In addition, the MCU 20 acquires a result of irradiating the RFIC 10 with vital extraction beams, extracts vital information of the respective objects 60 using the result, and transmits the vital information to the servers 70 via the networks 41.

When the server 70 acquires the information indicating that the object 60 is specified and the vital information, the server 70 determines the attributes of the object 60 for the detected number of times. Further, the server 70 determines whether or not to perform a control process for each controlled device 50 for each object 60, and performs a control process based on the determination result.

For example, the controlled device 50a is an IH stove, and the controlled device 50b is a television. The object 60a is a mother, and the object 60b is a child. When specifying that the object 60a is around the controlled device 50b, the device control system 1 controls to tune the channel to the program in the case where a favorite program set in advance is broadcasted. When the object 60b is specified to be in the vicinity of the controlled device 50a, the child lock is set.

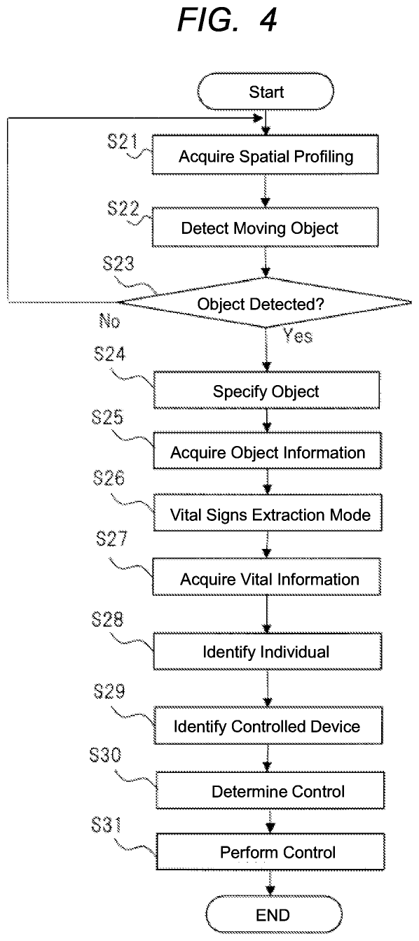

Next, a processing procedure in which the device control system 1 controls the controlled device 50 will be described with reference to the flowchart shown in FIG. 4.

Steps S21 to S23 are the same as steps S1 to S3 in the flowchart of FIG. 2. The step S24 is basically the same as the step S4 of FIG. 2, except that a plurality of objects 60 are detected. The method of detecting the plurality of objects 60 can be realized by using a known method. For example, the spatial profiling beam irradiation controller 22 performs control so as to irradiate a beam in a certain range.

Steps S25 to S31 are basically the same as steps S5 to S11 in the flowchart of FIG. 2. The difference is that the loop is performed for the number of objects 60 in which the steps S25 to S31 are detected.

Further, it is different in that the judgment and the control of the controlled device 50 are performed for several times in steps S30 and S31.

### Embodiment 3

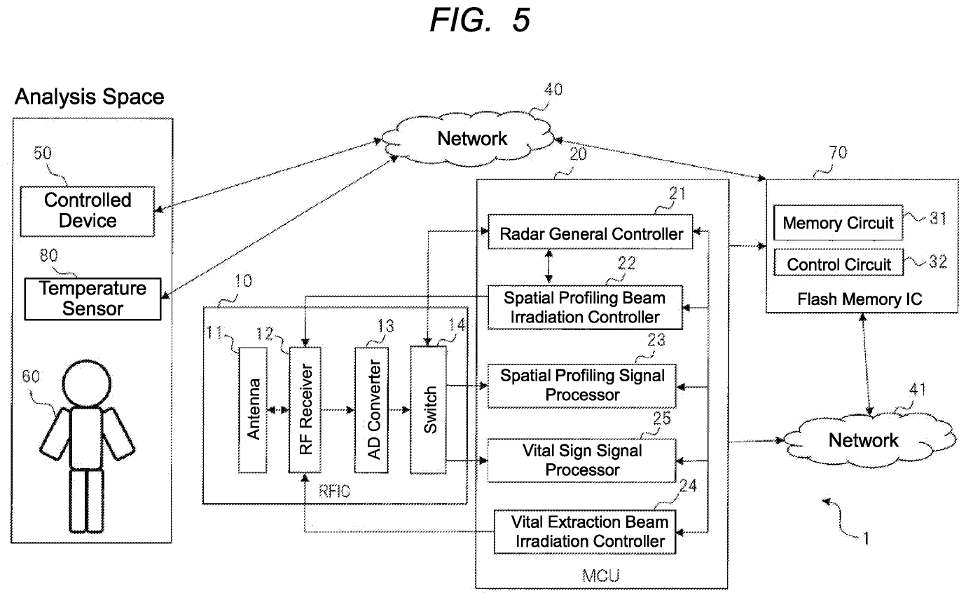

In the third embodiment, an external sensor provided in an analysis space irradiated with a radar beam is further used to control a device to be controlled. An example of the configuration of the device control system according to the third embodiment will be described with reference to FIG. 5. FIG. 5 is a diagram showing an outline of the device control system according to the third embodiment. Note that the description of portions common to the functions shown in FIG. 1 and FIG. 3 is omitted.

The difference between the first embodiment and the second embodiment is that the detection result of the external sensor is used. Here, as an external sensor, a temperature sensor 80 is disposed around a controlled device 50 such as an air conditioner.

The temperature sensor 80 can transmit a detection result (temperature information) to the server 70 via the network 40. The temperature sensor 80 sequentially transmits the detection result to the server 70 via the network 40.

When judging whether or not to control the controlled device 50 based on the identified individual and the controlled device 50, the controller 32 of the server 70 further judges whether or not to control the controlled device 50 by using the detection result of the temperature sensor 80. The external sensor is not limited to a temperature sensor, and other sensors may be used. For example, if the controlled device 50 is an air conditioner, a sensor capable of measuring humidity may be used as an external sensor.

### Embodiment 4

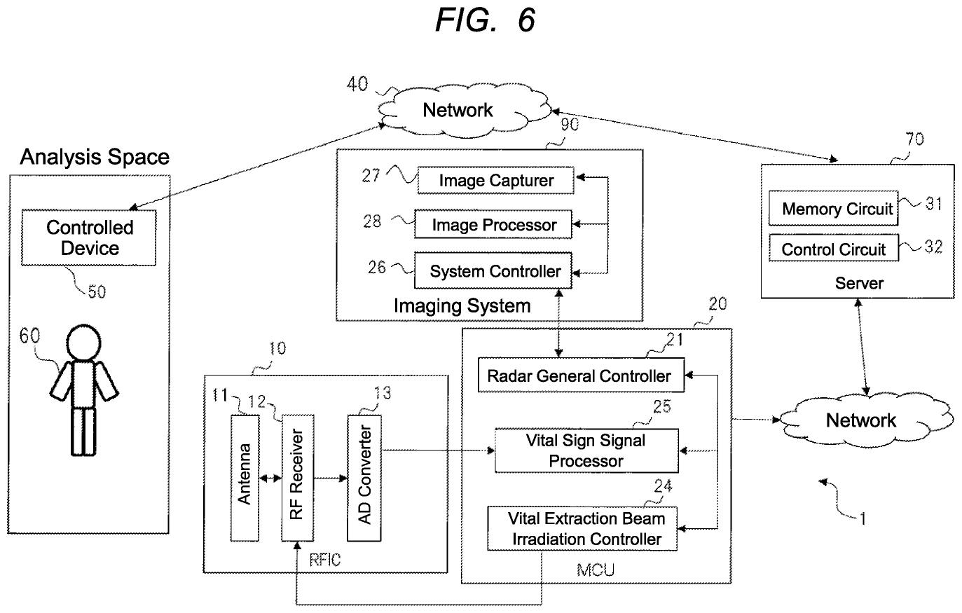

In the fourth embodiment, instead of irradiating the spatial profiling beam, the object 60 is detected by the imaging system, thereby controlling the device to be controlled. An example of the configuration of the device control system according to the fourth embodiment will be described with reference to FIG. 6. FIG. 6 is a diagram showing an outline of the device control system in the fourth embodiment. Note that the description of portions common to the functions shown in FIGS. 1, 3, and 5 is omitted.

The difference between the first to third embodiments is that, instead of irradiating the spatial profiling beam, the object 60 is detected by the imaging system 90.

The imaging system 90 is a system having an imaging unit, and includes a system controller 26, an imaging unit 27, and an image processor 28. The system controller 26 controls the imaging system 90. When the system controller 26 receives an image capturing request from the radar controller 21, the system controller 26 sends an image capturing request to the image capturer 27. When the system controller 26 acquires an image processing result (the shape of the object 60, the number of the objects 60, the position of the object 60, and the like) from the image processor 28, the system controller 26 sends the image processing result to the radar general controller 21.

The image capturer 27 is an image capturer that captures an image of an object 60 around the controlled device 50 that is a control target. For example, the image capturer 27 is a camera capable of capturing an image of the surroundings of the controlled device 50. The imaging unit 27 performs imaging in response to an imaging request from the system controller 26, and sends the imaging result to the image processor 28.

The image processor 28 performs image processing based on the image pickup result (image) by the image pickup unit 27. The image processor 28 specifies the presence or absence of the object 60, the number of the objects 60, and the shape and position of the object 60 by performing known image processing on the imaging result. The image processor 28 transmits the specified result to the system controller 26 as an image processing result.

Although the invention made by the present inventor has been specifically described based on the embodiment, the present invention is not limited to the embodiment described above, and it is needless to say that various modifications can be made without departing from the gist thereof. For example, the above-described embodiments have been described in detail in order to explain the present invention in an easy-to-understand manner, and are not necessarily limited to those having all the configurations described. It is also possible to add, delete, or replace some of the configurations of the above embodiments.

The present invention can be applied to a device control system for controlling a device to be controlled on the basis of an attribute or the like of an object existing around the device to be controlled.

What is claimed is:

1. A device control system comprising:
an object detection circuit configured to detect an object around a device to be controlled;
an attribute identification circuit configured to identify an attribute of the device; and
a control circuit configured to control the device based on a result of the detection by the object detection circuit and the attribute of the object identified by the attribute identification circuit.

2. The device control system according to claim 1, further comprising an attribute memory circuit configured to store criteria information which indicates criteria of the attribute of the object,
wherein the attribute identification circuit identifies the attribute of the object based on condition information of the object and the criteria information stored at the attribute memory circuit.

3. The device control system according to claim 2,
wherein the attribute memory circuit stores criteria of a shape, a blood pressure value, a heart rate, a pulse rate or a respiratory rate as the criteria of the attribute of the object, and
wherein the attribute identification circuit further configured to detect any value of the shape, the blood pressure value, the heart rate, the pulse rate or the respiratory rate as the condition information of the object.

4. A control method comprising:
detecting an object around a device to be controlled;
identifying an attribute of the device; and
controlling the device based on a result of the detecting and the attribute of the object obtained by the identifying.

5. A device control system comprising:
an RF circuit configured to irradiate a radar beam and receive a reflected wave of the radar beam by using an antenna;
an irradiate control circuit configured to control the radar beam by controlling the RF circuit;
a space profiling signal processing circuit configured to:
input the reflected wave;
detect a moving object by using the reflected wave;
specify a position and a shape of the moving object;
a vital sign signal processing circuit configured to detect a heart rate, a pulse rate, a blood pressure value or a respiratory rate of the moving object as vital information by using the reflected wave;
a memory circuit configured to store at least one of a shape, the heart rate, the pulse rate, the blood pressure value or the respiratory rate as a human attribute information; and
a control circuit configured to:
compare at least either of a shape of the moving object or the vital information with the human attribute information stored at the memory circuit;
specify the object;
control a target device based on information of the specified object,
wherein the irradiate control circuit controls the RF circuit to focus an irradiation area so that the vital sign signal processing circuit process the reflected wave.

6. The device control system according to claim 5,
wherein the control circuit controls the target device based on the information of the specified object and a distance between the position of the object and the target device.

7. The device control method according to claim 5, further comprising a temperature sensor disposed in the irradiation area of the radar beam,
wherein the control circuit controls the target device based on the information of the specified object and temperature information detected by the temperature sensor.
